(19) United States
(12) Patent Application Publication
(10) Pub. No.: US 2009/0325424 A1
(43) Pub. Date: Dec. 31, 2009

(54) Connecting Scheme for Orthogonal Assembly of Microstructures

(75) Inventors: Arno Aarts, Leuven (BE); Hercules Pereira Neves, Hamme-Mille (BE); Chris Van Hoof, Leuven (BE); Eric Beyne, Leuven (BE); Patrick Ruther, (US); Robert Puers, (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignees: INTERUNIVERSITAIR MICROELEKTRONICA CENTRUM (IMEC), Leuven (BE); KATHOLIEKE UNIVERSITEIT LEUVEN, Leuven (BE); Albert-Ludwigs-Universitat Freiburg Fahnenbergplatz, freiburg (DE)

(21) Appl. No.: 12/110,676

(22) Filed: Apr. 28, 2008

Related U.S. Application Data
(60) Provisional application No. 60/926,624, filed on Apr. 26, 2007.

(30) Foreign Application Priority Data
Apr. 21, 2008 (EP) 08154893

(51) Int. Cl. H01R 24/00; H01R 43/00

(52) U.S. Cl. 439/676; 29/884

(57) ABSTRACT

In the present disclosure a device for sensing and/or actuation purposes is presented in which microstructures (20) comprising shafts (2) with different functionality and dimensions can be inserted in a modular way. That way, out-of-plane connectivity, mechanical clamping between the microstructures (20) and a substrate (1) of the device, and electrical connection between electrodes (5) on the microstructures (20) and the substrate (1) can be realized. Connections to external circuitry can be realised. Microfluidic channels (10) in the microstructures (20) can be connected to external equipment. A method to fabricate and assemble the device is provided.

### TECHNICAL FIELD

The present disclosure relates to the field of microsystem integration. More particularly, the present disclosure relates to a device for sensing and/or actuating and a method for assembling probes for sensing and/or actuating on a substrate.

### BACKGROUND

In-plane to in-plane multi-contact MEMS connectors have been described by M. P. Larsson et al. (in IEEE J. Microelectromech. Sys., vol. 13, no. 2, pp. 365-376, 2004) and by T. Akiyama et al. (in Proc. 2001 Intl. Microprocesses & Nanotech. Conf., Shimane (Japan), pp. 52-53, 2001). In both cases, it is not possible to achieve in-plane to off-plane multi-contact connection.

M. P. Larsson et al. describe overhanging blades to provide spring action. As there is no bending of these structures into a cavity, there is no possibility of using this technology to assemble an orthogonal off-plane device onto this connector. Also multi-contact connection is not possible.

Toshiyoshi et al. (in Proc. SPIE, vol. 3680, pp. 679-686, 1999) describe the fabrication of fingers and matching holes; the fingers have metal plating on one of their surfaces and the hole has metal around it. Malhi et al., in U.S. Pat. No. 5,031,072, describe bonding at the corner between a motherboard and an upright connecting part. In both cases, multi-contact connection is not possible.

A three-dimensional probe array for neural studies assembling combs of probes onto a backbone has been obtained by fusing single contacts together through plating (A. C. Hoogerwerf et al. in IEEE Trans. Biomed. Eng., vol. 41, no. 12, pp. 1136-1146, 1994) or through corner bonding (Q. Bai et al in IEEE Trans. Biomed. Eng., vol. 47, no. 3, pp. 281-289, 2000). These connecting structures (cavities and matching posts) cannot contain a plurality of contacts. This approach results in a 3D probe array that requires additional space beyond the implanted length of the probe and thus increases the overall thickness of the platform.

US20040082875 describes a modular approach to building microprobe arrays for the brain that can incorporate probes of different pitches and different lengths. Each probe is made of conductive material and can only have one electrode.

U.S. Pat. No. 5,215,088 describes a fixed array of needles made out of a single piece of silicon. This approach is not modular and has no interconnect scheme.

US20060108678 describes an electroplating-based technology for building probe arrays. The approach is not modular and each probe can only have one electrode.

EP1637019 describes an interconnect scheme that permits connecting a two-dimensional array of spring structures to the land grid array.

N. Tanaka and Y. Yoshimura (Electronic Components and Technology Conference 2006, p 814-818) presented stacked dies using conventional in-plane flip chip technique in which the connection is made by using the caulking technique at room temperature. It is not possible to achieve in-plane to off-plane multi-contact connection.

U.S. Pat. No. 6,829,498 presents an implant device for neural interface with the central nervous system. The device may be configured as a three-dimensional structure and is capable of sensing multi-unit neural activity. The device has a big base that increases the overall thickness of the platform to be inserted in the skull.

### SUMMARY

It is an object of embodiments described herein to provide a device for sensing and/or actuating and a method for assembling, on a substrate, probes for sensing and/or actuating. Preferably, microstructures, also referred to as probes, with different functionality and dimensions can be orthogonally assembled in a modular way in a thin or slim base backbone with multiple interconnects.

In a first aspect, the present disclosure provides a device for sensing and/or actuating, in particular for sensing and/or actuating neural activity. The device includes:
a substrate having at least one cavity, wherein the substrate and the cavity have an insulating surface;
at least one microstructure with a connector part and at least one shaft, the connector part of each microstructure being inserted in one of said cavities; the microstructure includes at least one conductive area partially on the connector part and partially on the shaft;
at least one flexible conductive blade at the cavity, where a first part of the flexible conductive blade is outside the cavity and a second part is inside the cavity; the second part is located between a sidewall of the cavity and the connector part such that said conductive blades are in electrical contact with the conductive area on the connector part.

The dimensions of the cavity may substantially be matching the dimensions of the connector part of the microstructure.

The cavity and the connector part may have dimensions between 50 μm and 2000 μm.

The angle between the substrate and said at least one microstructure may be between 45° and 90°.

The width of the blades and the length of the second part of the blade may be between 1 μm and 100 μm.

According to embodiments described herein, the device may further include conductive paths on the substrate connecting the conductive blades with bond pads and/or integrated circuitry in the substrate.

The device may further include functional areas on the microstructure in contact with the conductive area.

The device may further include first microfluidic channels in the substrate and second microfluidic channels in the microstructure, the first and second microfluidic channels being connected to each other with sealed holes in the cavities.

According to some embodiments, the microstructure may be a needle.

The substrate may have a thickness between 200 μm and 2000 μm.

According to certain embodiments, the substrate may be a semiconductor, e.g. silicon wafer or a thinned semiconductor, e.g. silicon wafer covered with insulating material, e.g. silicon oxide.

The conductive area and the blade may comprise at least one conductive material.

The at least one blade may comprise a flexible material.

The substrate, the microstructure, the conductive blade and the conductive area may be made of or covered with biocompatible materials.

In a further aspect, the present disclosure describes the use of devices as described herein for measurements and/or actuation of neural activity.

In another aspect, the present disclosure provides a method for assembling on a substrate microstructures for sensing and/or actuating, in particular for sensing and/or actuating neural activity. The method comprises:
obtaining a substrate with at least one cavity, the substrate and the cavity having an insulating surface, the substrate furthermore having at least one flexible conductive blade near each cavity, the conductive blade partially overhanging the cavity,
obtaining at least one microstructure comprising a connector part, at least one shaft, and at least one conductive area partially on the connector part and partially on the shaft, the connector part being shaped such as to fit into a cavity, where the conductive area on the connector part is located so as to contact the conductive blades near the cavities upon insertion;
inserting the connector part of the microstructure in the cavity, thereby bending the flexible conductive blade in the cavity and realizing electrical contact between the flexible conductive blade and the conductive area on the connector part of the microstructure; and
fixing the connector parts inside the cavities.

The method may further comprise fabricating functional areas on the microstructures in contact with the conductive area.

The method may further comprise providing bond pads on the substrate and/or integrated circuitry in the substrate and providing conductive paths on the substrate connecting, at one side, the flexible conductive blade, and at the other side, the bond pads on the substrate and/or integrated circuitry in the substrate.

According to embodiments described herein, the method may further comprise:
providing first microfluidic channels in the substrate and second microfluidic channels in the microstructures, whereby each of the first microfluidic channels is connected to at least one of the second microfluidic channels via a hole in the cavity; and
sealing the holes in the at least one cavity.

The method may further comprise connecting the flexible conductive blade and/or the microfluidic channels to measurement equipment.

The flexible conductive blade may be provided by:
filling the cavity with a sacrificial material;
providing the conductive blade partially on the sacrificial material;
optionally providing conductive paths in electrical contact with the blade; and
removing the sacrificial material from the cavities.

The sacrificial material may, for example, be polyimide or Benzocyclobutene (BCB).

Providing the flexible conductive blade and the conductive paths may be performed by metal deposition and lift-off or by metal deposition and patterning by dry and/or wet etching.

Realizing electrical contact between the at least one flexible conductive blade and the at least one conductive area may be done by caulking.

The dimensions of the connector part may be slightly larger or smaller than the dimensions of the cavities. In that case, fixing the connector parts in the cavities may be performed by:
creating a temperature difference between the substrate and the microstructure such as to allow insertion of the connector parts into the cavities;
inserting the connector parts in the cavities; and
bringing the substrate and the microstructure to the same temperature.

In another aspect, the present disclosure provides a device for connecting microstructures and/or probes with different functionalities to other equipment, where each microstructure and/or probe has a connector part. The device includes:
an insulating substrate;
cavities in the insulating substrate, the dimensions of the cavities being chosen such that a connector part of a microstructure and/or probe can be inserted in the cavities. The dimensions of the cavities are chosen to match the dimensions of the connector part of the microstructure and/or probe; and
flexible blades overhanging the cavities.

According to embodiments described herein, the flexible blades are conductive. The conductive flexible blades may be adapted for matching conductive strips or regions on the connector part of the microstructures and/or probes. In this case, conductive strips on the connector part of the microstructure and/or probe can be electrically connected to functional regions on the microstructure and/or probe. These functional regions on the microstructure and/or probe allow different measurements and can also allow activation. When the microstructure and/or probe is inserted in a cavity, the overhanging conductive blades or flaps bend inside the cavity and contact the corresponding conductive strips or regions on the connector part of the microstructure and/or probe.

A device according to embodiments described herein may further comprise conductive lines on the insulating substrate in between said cavities, whereby the conductive lines are at one side in electrical contact with said conductive flexible blades or flaps and at the other side in contact with integrated circuitry or bond pads or conductive strips on said substrate.

A device according to embodiments described herein may further comprise first microfluidic channels in said insulating substrate and second microfluidic channels in at least one of said microstructures and/or probes. One end of the first microfluidic channels is located in the cavity or cavities, and one end of the second microfluidic channels is located at the connector part of the microstructure and/or probes. Each of the ends of said first microfluidic channels is adapted in shape and location to be in contact with a corresponding one of the ends of the second microfluidic channels.

In yet another aspect, the present disclosure provides a method for fabricating a device for connecting microstructures and/or probes with different functionalities to other equipment. Each microstructure and/or probe has a connector part. The method includes the following steps:
providing a semiconductor, e.g. silicon, wafer;
etching cavities in the semiconductor, e.g. silicon, wafer,
depositing insulating material, e.g. silicon dioxide, on the semiconductor, e.g. silicon, wafer;
coating the substrate at the side of the cavities with a sacrificial material, for example polyimide;
planarizing the wafer surface thereby completely removing the sacrificial material, e.g. polyimide layer, from the non-etched regions of the wafer;
depositing conductive, e.g. metal, blades or flaps partially on the sacrificial material, e.g. polyimide, on the cavities;
depositing conductive, e.g. metal, tracks in electrical contact with the blades or flaps; and
removing the remaining sacrificial material, e.g. polyimide, from the cavities.

In yet another aspect, the present disclosure provides a method for fabricating a device for connecting microstructures and/or probes with different functionalities to other equipment. Each microstructure and/or probe has a connector part. This method includes the steps of:
providing a semiconductor, e.g. silicon, wafer;
etching cavities in the semiconductor, e.g. silicon, wafer,
depositing insulating material, e.g. silicon dioxide, on the semiconductor, e.g. silicon, wafer;
coating the substrate at the side of the cavities with a sacrificial material, for example polyimide;
planarizing the wafer surface thereby leaving a layer of sacrificial material, e.g. polyimide, on the wafer;
removing the sacrificial material, e.g. polyimide, on at least the non-etched regions. This means that all sacrificial material, e.g. polyimide, is removed where no cavities are present. At the edges of the cavities also some sacrificial material, e.g. polyimide, can be removed. The sacrificial material, e.g. polyimide, on top of the major part of the cavities is not etched. At these locations on the cavities the sacrificial material, e.g. polyimide layer, is located above/at a higher level than the initial substrate surface;
depositing conductive, e.g. metal, blades or flaps partially on the sacrificial material, e.g. polyimide, on the cavities;
depositing conductive, e.g. metal, tracks in electrical contact with said blades or flaps;
removing the remaining sacrificial material, e.g. polyimide, from the cavities.

In a method according to embodiments described herein, providing cavities in the semiconductor, e.g. silicon, substrate may include the steps of:
coating the semiconductor, e.g. silicon, wafer with a layer of insulating material, e.g. silicon dioxide;
patterning the insulating material, e.g. silicon dioxide. This can be done by lithography, followed by etching of the insulating material, e.g. silicon dioxide layer, using any suitable etching process, e.g. reactive ion etching (RIE);
transferring the patterns in the insulating material, e.g. silicon dioxide layer, to the underlying semiconductor material, e.g. silicon. This can be done by any suitable method, e.g. deep reactive ion etch (DRIE).

In a method according to embodiments described herein, depositing the conductive, e.g. metal, blades and the conductive, e.g. metal, tracks in electrical contact with the blades may comprise the steps of:
depositing a conductive, e.g. metal, seed layer on the entire surface;
defining patterns for the conductive, e.g. metal, tracks and overhanging blades or flaps in a resist layer;
electroplating conductive material, e.g. gold. This will be plated on the regions not protected by the resist;
removing the resist layer;
removing the seed layer in the areas not covered with the conductive material, e.g. gold.

Particular and preferred aspects of the invention are set out in the accompanying independent and dependent claims. Features from the dependent claims may be combined with features of the independent claims and with features of other dependent claims as appropriate and not merely as explicitly set out in the claims.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1: Perspective view of a backbone concept wherein combs or probes are assembled into a 3D array.

FIG. 2: Cross-sectional view of the assembling process; (a) The female connecting microstructure contains a series of overhanging conductive blades (lines); (b) the male connecting microstructure contains matching conductive strips (lines top part); (c) as insertion takes place, the male connecting microstructure pushes the conductive blades into the cavity of the female connecting microstructure; (d) the conductive blades end up squeezed between the side wall of the female connecting microstructure cavity and the male connecting microstructure.

FIG. 3: (a) Cross-sectional side view of a device illustrating clamping of a connector part of a probe in a cavity in a base by means of a conducting blade; (b) and (c) are respectively a top view and a three-dimensional view of a structure for clamping a probe in cavities in a base.

FIG. 4: (a) Top view of the cavity showing a plurality of contacts or overhanging blades within one microstructure. The dark rectangle shows the cavity itself and the conductive blades leading over the edge of the cavity are in dashed lines; (b) a male connecting microstructure (dotted at the top) is inserted into the female connecting microstructure (dotted at the bottom). It shows that in-line metal tracks (dashed lines) on the microstructures match metal tracks at the cavity edge. The contact is established by contact blades, leading over the edge of the cavity bending into the cavity and being squeezed between the cavity wall and the contact pad of the inserted microstructure.

FIG. 5: Examples of geometry of the blades. The intention of the different profiles is to relieve the stress imposed on the blade during insertion of the male connecting microstructure and/or to provide extra spring action to push the blade against the matching conductive strip.

FIG. 6: Cross-section of an assembled male-female pair, including electrodes and microfluidic channels in/on both connecting microstructures. Once assembled, a single microfluidic conduit is created through the male and female parts.

FIG. 7: Close-up of details of the cavity, including electrical wiring towards the blades. The cavity is depicted in dashed lines and the conductive material, e.g. metal, (which contains all the connecting tracks and as well as the overhanging metal blades) is depicted in black.

FIG. 8: Design of electrical connections on the base, containing a 4×4 array of cavities.

FIG. 9: Fabrication steps. The process starts (a) with a semiconductor material, e.g. silicon wafer, which is coated (b) with a layer of electrically insulating material, e.g. plasma-enhanced vapor deposition (PECVD) of silicon dioxide. Lithography is performed, followed by the etching of the electrically insulating material, e.g. oxide layer, using any suitable method, e.g. reactive ion etching (RIE) and the transfer of the patterns formed by lithography to the underlying semiconductor material, e.g. silicon, by any suitable method, e.g. deep reactive ion etch (DRIE), (c). Another layer of electrically insulating material, e.g. PECVD silicon dioxide, is provided (d) e.g. deposited to provide electrical insulation inside the cavities, followed by the coating (e) of the surface with a thick layer of sacrificial material, e.g. polyimide. An initial planarization step (f) is performed e.g. by grinding the sacrificial material, e.g. polyimide, with a wafer grinder, leaving a layer of polyimide on the top regions of the wafer. A second lithography step is performed to create a step on the sacrificial material, e.g. polyimide, which will add spring action to the blades and facilitate their bending. This is followed by RIE of the polyimide to completely remove it from the top regions around the lithographically defined areas (g). A conductive, e.g. metal, seed layer is deposited (h) on the entire surface. A resist layer is provided, and a third lithography step is done (i) to define the patterns for the metal (tracks and overhanging blades). Conductive material, e.g. gold, is then electroplated (j) on the regions not protected by the resist, after which the resist is removed (k). The seed layer is etched from the open areas (l) and the remaining sacrificial material, e.g. polyimide, is completely removed from the cavities (m). As a result the blades are hanging over the cavity.

FIG. 10: Cross-section of (a) a blade and (b) the shape of a blade resulting from the use of a lithographically defined step around the cavity (as obtained using the process described in FIG. 9).

FIG. 11: Scanning electron micrograph of overhanging blades on a cavity.

FIG. 12: Scanning electron micrograph showing the two step electroplated gold clips leading over the edge of the cavity.

FIG. 13: Scanning electron micrograph of a 4×4 probe array on a base backbone.

FIG. 14: Schematic illustration of (a) microsystems connected in an in-plane fashion and (b) microsystems connected in an out-of-plane fashion, also called orthogonal assembly of microsystems.

In the different figures, the same reference signs refer to the same or analogous elements.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and that the embodiments of the invention described herein can operate in other orientations than described or illustrated herein.

The term “comprising”, used in the claims, should not be interpreted as being restricted to the means listed thereafter; it does not exclude other elements or steps. It should be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

The invention will now be described by a detailed description of several embodiments of the invention. It is clear that other embodiments of the invention can be configured according to the knowledge of persons skilled in the art without departing from the true spirit or technical teaching of the invention, the invention being limited only by the terms of the appended claims.

Understanding of neuronal operations in the brain can be achieved by electrical recording of single-neuron activity. Recordings from the brain allow investigating the activity of individual neurons, especially the interaction between electrical and chemical signals related to short and long term changes of morphology and information transfer. These measurements are often performed with single electrodes or small ensembles of electrodes.

Multi-electrode arrays can allow simultaneous recording of electrical signals at different locations. This is advantageous as this can increase the number of neurons recorded and can give information on the interaction between different neurons. Often multiprobe arrays only allow sampling in a given plane, either a plane parallel to the surface or a plane orthogonal to the surface.

Arrays in which 3D geometry can be achieved, would allow 3D recordings of parts of the brain. This can provide laminar information and information on the functional organization such as columnar or patchy organizations in primary and associative cortex. That way it could become possible to record at the local network level between neurons, i.e. the interaction of neighbouring neurons can be recorded. If stable recordings from the same cortical regions can be obtained over extended periods of time, changes in population activity can be studied, both at single neuron level and at the interaction level with learning, memory and training.

Multi-electrode arrays of which the 3D geometry can be adapted to the folding of the cortex can be interesting. This can be achieved with a modular approach, allowing the individual assembly of multiple probes with customized architecture into three-dimensional arrays to address specific brain regions. That way, sulci of highly folded cortices such as those of humans can be contacted.

Also interesting are correlation studies in which the causal relationship between neuronal stimulation or inactivation and neuronal activity is investigated. Neuronal stimulation can be achieved by electrical stimulation techniques using for example microwires. Inactivation can for example be achieved by injecting locally pharmacologically active substances to temporally silence neuronal activity. The location of stimulation or inactivation needs to be assessed functionally. Therefore multifunctional arrays can be used in which recording can be combined with stimulation and fluid can be delivered through the recording channels. Integration of electrical recording with direct measurement of transmitter release can allow describing the functioning of a cerebral region both in electrical and chemical terms.

A modular approach allows the integration of recording and stimulation electrodes, biosensors, microfluidics and integrated electronics. When the individual probes are present, a device can quickly be assembled according to the particular application.

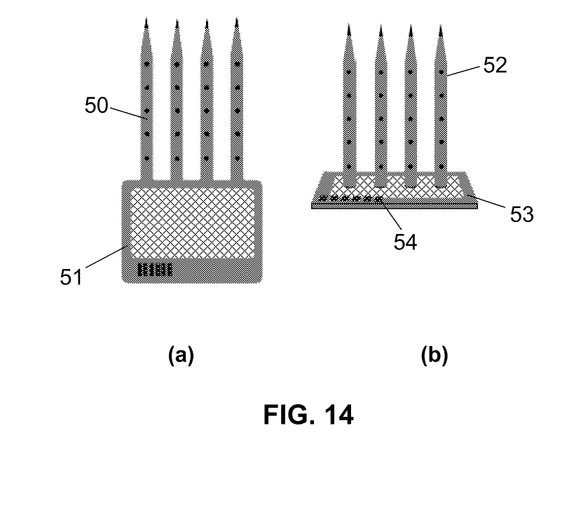

Microfabricated elements are often fabricated in an in-plane fashion (see FIG. 14(a)) and electrical connections in microsystems often have in-line connectivity between microsystems 50 that are parallel to each other. In that case, a substrate 51 is processed additively, for example by surface micromachining through the deposition, patterning and etching of thin films or subtractively, for example by bulk micromachining through the patterning and etching of the substrate 51 or a combination of both. The resulting structure is then predominantly in the same plane as the original substrate 51.

Orthogonal assembly of a microsystem 52 onto a substrate 53 (FIG. 14(b)) uses in-line connections using the edge of the standing piece or bonding to metal strips one by one to establish connection between each pair of orthogonal contact pads 54. This assembling method tends to be time consuming, expensive, and unreliable.

In exemplary embodiments described herein, in-plane structures are assembled in an out-of-plane fashion, i.e. structures are assembled orthogonally on a common base. The structures can also make a non-orthogonal angle to the base. That way spatial complexity is enabled while preserving functionality such as electrical and fluidic interconnects. Matching mechanical and electrical features of two microstructures are joined together orthogonally or under a predetermined angle. Exemplary embodiments describe here include a connector mechanism that makes it possible to assemble microfabricated elements (such as a microstructure/probe and base) orthogonally or under an angle, to make a microsystem.

An advantage of embodiments described herein is the fact that the base or backbone can generally be made thinner than in prior art systems. This can be interesting for several applications, as the base consumes only limited additional space beyond the implanted length of the probe array. For example in neural applications this can be interesting. In that case it may allow the base with probes to float with the brain (i.e. to move together with the brain, so not to be attached to the skull).

In the text below, the base, backbone, or support all mean the same connecting device. In the base, there are cavities, also called holes. Overhanging these cavities, there are blades, also called flaps or clips. In the base, microstructures or probes can be inserted.

A modular approach for assembling probes is presented. One or more of the following features are provided in any or all of these embodiments:
Possibility of assembling probes of multiple lengths and configurations (electrode quantity and pitch, presence of open areas, multiple probe profiles, etc), which allows probing in 3 dimensions.
Possibility of assembling probes orthogonally or under an angle different from 180° on the base.
Possibility of assembling probes of different functionalities (electrical measurements and stimulation, temperature sensing, drug delivery, biosensors) combined with electrical probes for recording and stimulation, in any desired configuration and size.
Electrical connection between the conductors on the probe and the conductors on the base can be achieved orthogonally.
Possibility of including various/more than one electrical connection on one probe.
Possibility of including different functionalities on one probe.
Microfluidic channels can be introduced, thereby allowing integration with fluidic valves and pumps.
Electrical connection with integrated electronic circuitry on the base or electrical connection with other equipment (for measurement and analysis) is possible.
Possibility of aligning, mechanically locking, or clamping probes in the base.
The possibility to use a very thin base.
Scalability.

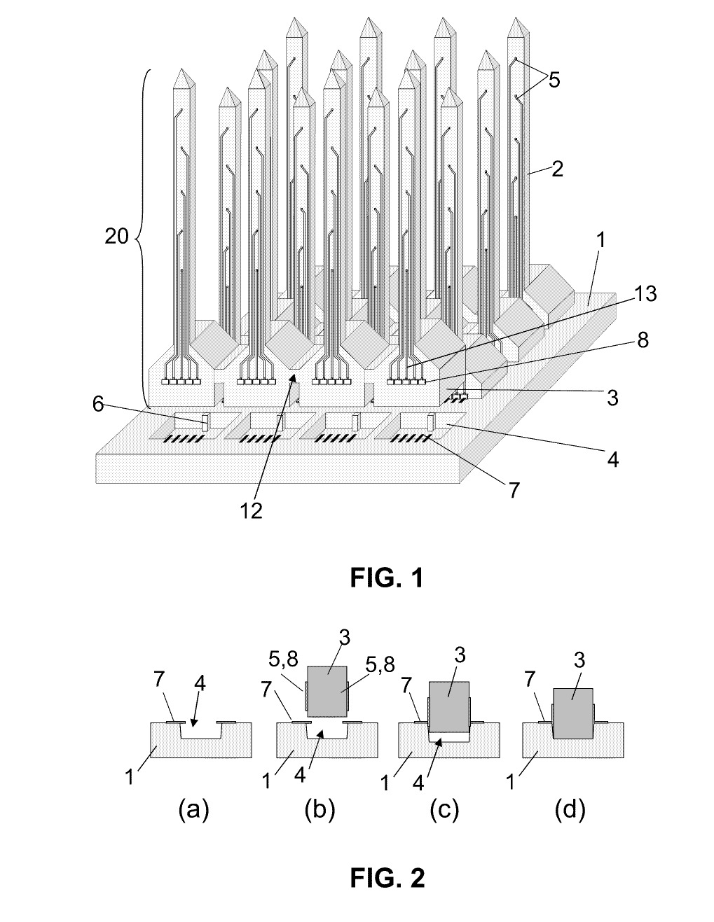

In a preferred embodiment, (see FIG. 1) a device is provided for sensing and/or actuating comprising a substrate 1, e.g. a semiconductor substrate such as a silicon substrate, also referred to as base or support or backbone, in which microstructures 20, also referred to as probes or out-of-plane structures, with different functionality and dimensions can be inserted in a modular way. In the following description, the terms substrate, base, support and backbone will be used next to each other. It has to be understood that these terms all indicate the same thing, i.e. that the female part of the device in which cavities are formed for providing the connector parts for the microstructures 20. Similarly, the terms microstructures, probes or out-of-plane structures will also be used next to each other and are also intended to indicate a same entity, i.e. the male structures that are inserted in cavities 4 of the substrate 1 for forming the assembled device. The microstructures 20 comprise a shaft 2 and a connector part 3, the connector part 3 having a shape matching in cavities 4 in the base 1. Electrical interconnection of the electrodes to an external circuitry as well as connections to microfluidic channels can be obtained via the common base 1 (see below). That way multiple microstructures 20 can be integrated to a 3D-probe array. The base 1 can provide mechanical support, electrical connectivity, and connectivity between microfluidic channels between the probes 20 and the outside world. The base 1 can be made thin, depending on the depth of the cavities 4 (see below).

An example of an application of the device provides a base 1, also called support or backbone, in which probes 20 for cerebral applications with different functionality and dimensions can be inserted in a modular way. In particular, a combination of electrodes 5 on a probe 20 that could be a needle-like structure having electrodes 5 at the tip and along the shaft 2 can be used. At the bottom a broader connector part 3 can be provided to be inserted in the base 1 (see FIG. 1). The modular approach allows assembling the probes 20 either in groups of comb-like structures or individually onto a common base 1 (FIG. 1). The conductive area on each probe 20 may comprise the electrodes 5 and connector pads 8 on the connector part 3. The cavity 4 may have an electrically insulating inner surface. This can be an electrically insulating layer deposited on the substrate, e.g. semiconductor substrate, in which the cavities are produced (e.g. a SiO₂ layer deposited on Si), or said substrate 1 can itself be made from an insulating material (e.g. a polymer). Overhanging conductive, e.g. metal, blades 7 are present at the side of the cavities, to establish electrical contact between the probes 2 and the base 1 (see below). In another application, microstructures or probes 20 with fluidic channels can be inserted in cavities 4 in the base 1.

This allows direct drug delivery during electrophysiological monitoring. Another possibility is to locally isolate clusters of neurons to measure neuron activity on cell level.

The etched cavity with the overhanging conductive, e.g. metal, blades 7 can also be a MEMS connector which can be integrated with fluidics. This MEMS connector can be used in applications such as adaptive lens configuration and piezoelectric or acousto-electric sensing. Introducing the MEMS connector with optics and fluidics would be very interesting for opto-fluidic applications.

The MEMS connector can also be used when integrating different techniques on a medical catheter like chemical- and biological sensors. Integration of optical actuators and sensors can be very useful for biomedical image processing and pattern recognition.

In general, the probe 20 can comprise a sensing and/or actuating part at the top, a shaft 2 comprising conductor parts or electrodes 5, 8, and a connector part 3 at the bottom for being inserted in cavities 4 of the base 1. Electrical connections and other connections, such as microfluidic channels can be included on/in the probe 20, running over/in the shaft down to the connector part 3 at the bottom.

An example of a probe 20 can be a needle for sensing and actuating purposes in the brain. It can comprise a chisel-type tip, a needle-like shaft 2, and a connector part 3 at the bottom. Each probe shaft 2 can contain a number of electrodes 5. In case of assembling passive probes 20 the number of electrodes 5 on the shaft 2 may be limited because the amount of contact pads on the connector part 3 of the probe 20 is limited. A pitch density of 70 μm up to 35 μm can be achieved on the connector part 3. In that case the number of electrodes 5 can vary between 1 and 50 or between 1 and 25, or between 5 and 11. In case of assembling active probes 20, so when multiplexing is done, the shaft 2 of the probe 20 can be completely covered with electrodes 5. In the latter case, for example CMOS processing can be used to realise the high density of electrodes 5.

Probes 20 can be mounted on a base 1 individually or comb-like in groups to facilitate assembly. Also pairs or multiple combs of probes 20 can be assembled on a common connector part 3. Also probes 20 with additional functionality such as microfluidics to dispense drugs and/or extract body fluids as well as biosensors to detect biomolecules can be added.

The probes 20 can be mounted substantially orthogonally on the base 1 (angle=90° or a slight deviation thereof, e.g. less than 10%, preferably less than 5%, more preferred less than 1%, still more preferred less than 0.1%) or can make a predetermined angle with the base 1. The angle between the probes 20 and the base 1 can be between 90° and 80°, between 90° and 70°, between 90° and 60°, between 90° and 45°, between 80° and 70°, between 85° and 60°, between 89° and 45°. In principle, any other angle different from zero can also be achieved to mount the probes under a predetermined angle with respect to the base 1.

The connector part 3 of a probe 20 is adapted to be inserted in the base 1. Therefore, cavities or holes 4 are provided in the base 1 to mount the different kinds of probes 20, depending on the needs of the application. The base 1 can comprise an array of several cavities 4. This can be for example 10×10 cavities, 5×5 cavities, or 4×4 cavities, 2×4 cavities, 5×10 cavities or any other combination that may be required for a particular application. The pitch between cavities 4 can vary, but is not limited hereto, between 100 μm and 2000 μm, between 200 μm and 1000 μm, or between 300 μm and 700 μm.

The in-plane dimensions of the cavity 4 can match the dimensions of the connector part 3 of the microstructures or probes 20, in such a way that it allows inserting the connector part 3 of the probe 20. The in-plane dimensions (x and y) can be, but are not limited hereto, in between 100 μm and 2000 μm, even better between 200 μm and 500 μm, or even better between 300 μm and 400 μm. The in-plane dimensions x and y can be the same or can be different, i.e. a cross-section of the cavity 4 in a direction parallel to the substrate surface can have a square or a rectangular shape, respectively. However, in alternative embodiments the cross-section of the cavity 4 in a direction parallel to the substrate surface can have any other suitable shape, such as e.g. circular, oval, trapezoidal, etc.

According to some embodiments, to easily insert the connector parts 3 of the probes 20 into the base 1, the connector parts 3 should have a shape corresponding to the shape of the cavities 4, and the in-plane dimensions of the cavities 4 may substantially match the dimensions of the connector part 3 in at least one direction. With substantially match is meant that the cavities 4 and the connector parts 3 of the probes 20 may have substantially the same dimensions, although the dimensions of the connector parts 3 can be a little smaller than the dimensions of the cavities 4 in order to allow easy insertion of the connector parts 3 into the cavities 4. To mechanically clamp the microstructures or probes 20 in the cavities (for example by optimising the dimensions, geometry, and materials of the overhanging blades), the difference in dimensions can thus be chosen relatively small. The difference in dimensions between the in-plane dimensions of the connector part 3 and the cavities or holes 4 in the base 1 can be, but is not limited hereto, between 1 μm and 10 μm, even better between 3 μm and 8 μm, even better between 4 μm and 6 μm.

According to other embodiments, the cavities 4 and the connector parts 3 of the probes 20 may have different shapes and the in-plane dimensions of the cavities 4 may substantially match the dimensions of the connector parts 3 in one direction. For example, the cavities 4 may have a square shape while the connector parts 3 have a rectangular shape. The length of the rectangular connector parts 3 may be of substantially a same size as the sides of the square cavities 4. The width of the rectangular connector parts 3 may then be smaller than the size of the sides of the square cavities 4. In that way, the in-plane dimensions of the cavities 4 may substantially match the dimensions of the connector parts 3 only in one direction.

After assembly, the inserted microstructure 20 can make contact with interconnects for making, for example electrical contact. This can be achieved in different ways. According to an embodiment, the overhanging blades 7 can clamp or press the inserted microstructure 20 in the holes or cavities 4 (see FIG. 2).

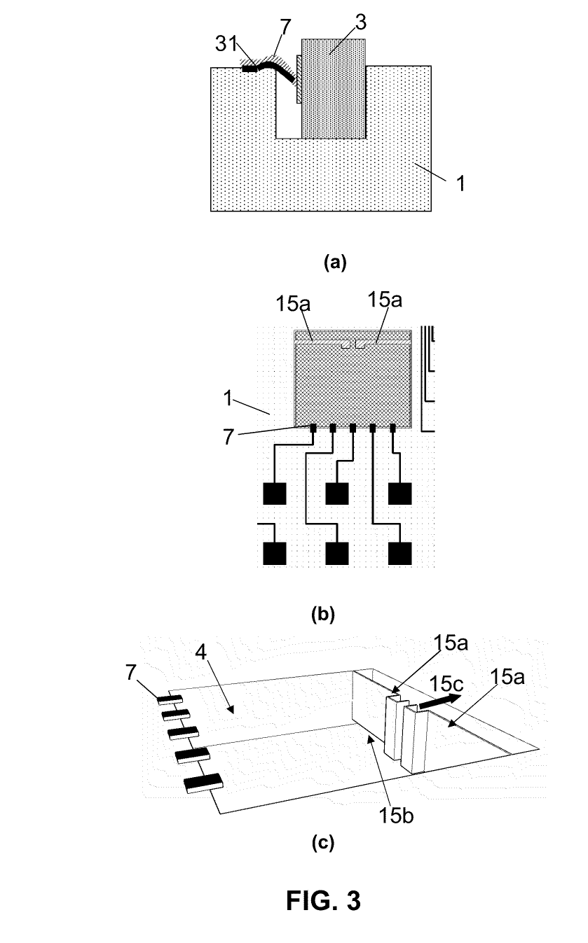

In another embodiment, clamping and electrical connection can be realised by using an elastic material 31, for example silicone, underneath the overhanging blades 7, e.g. metal blades (see FIG. 3 (a)). Also, the difference in dimensions between the connector part 3 and the cavity 4 can be cancelled out. In that way, an elastic blade 7, 31 may be obtained. The elastic blade 7, 31 (which may then comprise an elastic material 31 coated with blade material e.g. gold) tends to go back to its original form and will be pressed against a contact pad in the assembled structure.

In another embodiment, a built-in clamping structure 15 a can be used after assembly to press the inserted structure against the interconnects. This is illustrated in FIGS. 3 (b) and (c). FIG. 3 (b) shows a top view and FIG. 3 (c) shows a three-dimensional view of a clamping system. One side of the cavity 4 may comprise overhanging blades, e.g. gold blades and another side may comprise the clamping structure 15a which may, according to the present example, comprise elastically movable or thus flexible beams, e.g. silicon beams 15a. The elastically movable or thus flexible beams, e.g. silicon beams 15a, are attached with one side to a sidewall of the cavity 4. In between the bottom of the cavity 4 and the clamping structure 15a there may exist a gap which is in FIG. 3 (c) indicated by reference number 15b. Hence, it can be said that the clamping structure 15a, e.g. the silicon beams 15a are movably attached to the cavity 4. When the microstructure 20 is assembled into the cavity 4 the clamping structure 15a, in the example given the silicon beams 15a, which may also be referred to as cantilevers, are pressed backwards, i.e. in a direction away from the overhanging blades 7, e.g. gold blades (indicated by arrow 15c in FIG. 3 (c)), thereby offering resistance to and thus exerting a counter force on the connector part 3 of the microstructure 20 in a direction towards the overhanging blades 7, e.g. gold blades. In that way, the connector part 3 of the microstructure 20 may be clamped in the cavity 4.

In another embodiment, glue dispensed inside the cavity 4 prior to assembly can enhance the mechanical stability and can press the microstructure against the contacts.

In another embodiment, the dimensions of the connector part 3 can be slightly smaller or even a little larger than the dimensions of the cavities 4. The difference in dimension is preferable less than one micrometer. In case the dimensions of the connector part 3 are slightly larger than the dimensions of the cavities 4, to insert and mechanically clamp or lock the microstructures or probes 20 in the cavities 4, according to this embodiment, the base 1 can be heated, such that it expands and consequently the cavities 4 become slightly larger. Expanding of the cavities 4 occurs because the depth of the cavity 4 is much smaller then the thickness of the base 2 (For 8 inch wafers this will be around 725 μm). The temperatures that can be used depend on the material of the base 1, on the properties of the material or materials deposited on the base 1, and on the material properties of the inserted microstructure 20. The temperature can be for example between 50° C. and 500° C., between 100° C. and 300° C., between 150° C. and 250° C., but is not limited hereto. Depending on the bulk material of the base 1 the cavity 4 will expand thereby realising larger dimensions of the cavities 4 due to the thermal expansion coefficient and the probe or microstructure 20 can be inserted in the cavities 4. After cooling down, the dimensions of the cavities 4 go back to their original size and the probe 20 is clamped into the cavity 4. If clamping is too limited, extra clamping means can be used, for example by any of the embodiments described above.

In another embodiment, another way of inserting the microstructures 20 in the cavities 3 in case the dimensions of the connector part 3 are a little larger than the dimensions of the cavities 4, is cooling of the inserted microstructures or probes 20. For example cooling by using liquid nitrogen can realise a bigger temperature difference between the base 1 and the probes 20. The dimensions of the probes 20 will shrink depending on the material of the probes 20 and consequently the probes 20 can be assembled in the cavities 4 of the base 1. Going back to room temperature, the probes 20 return to their original size and are then clamped in the cavities 4. In that case, the overhanging blades 7 can for example be bent and squeezed between the cavity wall and the contact pad 8 of the probe or microstructure 20 resulting in a mechanically stable assembly. If desired, also extra clamping can be used, for example by any of the embodiments described above.

The electrical connection can also be made by a metal caulking technique. Metal caulking is a way of thermo-compressive bonding of metal. In this technique, pressure is increased locally such that locally a higher temperature is obtained such that the metal can locally melt so as to form an electrical connection or bond. The assembly can be done using a flip chip bonder.

The aspect ratio (depth/width) of the cavities or holes can be between 0.2 and 1, even better between 0.3 and 0.7, even better between 0.4 and 0.6.

The depth of the cavities or holes can be several hundreds of μm. The depth can vary between 50 μm and 2000 μm, even better between 100 μm and 1000 μm, or even better between 150 μm and 250 μm. In some embodiments the cavities or holes are not etched completely through the wafer.

When the depth of the cavities 4 is limited, i.e. when the depth of the cavities 4 is much smaller than the thickness of the base 1, the thickness of the base 1, for example a silicon wafer, can be reduced, for example by grinding it. This may be done before or after formation of the cavities 4. Thinning of the base 1 results in a thinner base in which the microstructures or probes 20 can be inserted. This can be interesting for example in neural applications, where it could allow the base 1 with probes 20 to float with the brain and not to be attached to the skull. The thickness of the base 1 can be between 150 μm and 2500 μm, for example between 50 μm and 2000 μm, between 200 μm and 1200 μm, between 100 μm and 1000 μm, or between 200 μm and 400 μm, for example between 150 μm and 250 μm. In case of, for example, an 8 inch silicon wafer the initial thickness is 725 μm, which can be thinned down to a thickness of, for example, between 100 μm and 600 μm, between 200 μm and 500 μm or between 250 μm and 400 μm

A small notch 6 in the cavity 4 (see FIG. 1) can facilitate alignment of the connector part 3 with respect to the base 1. The connector part 3 then has a corresponding slot. The size of the notch 6, and hence of the slot, can vary and may for example be, but is not limited hereto, between 10 μm and 500 μm, between 20 μm and 200 μm, or between 30 μm and 100 μm.

Provisions can be made to stop insertion of the probe 20 at a certain depth in the cavities 4. For this purposes, the notch 6 mentioned above can also be used. For example, the notch 6 can have a protrusion which blocks the probe 20 from being inserted deeper. In alternative embodiments, the height of the notch may be larger than the height of the corresponding slot in the probe 20, so as to also stop insertion of the probe 20 at a predetermined dept, being the dept of the slot. Stopping the probes 20 at a certain depth can also be done by adding a small piece inside the cavity 4 at a predetermined depth. This could also be done by a movable piece, such that the depth of the probe 20 inside the cavity 4 can be changed. The movable piece may, for example, be a plate which fits in the cavity 4 and which may form a movable bottom side of the cavity 4. By moving the plate, the depth of the cavity 4 can be varied. The cavities 4 can also be shaped such that they have a width becoming smaller and smaller when going deeper in the cavity 4. The cavities 4 then have a tapered shape. In that way, this can also stop the probes 20 at a predetermined depth, depending on the sizes of the cavities 4 and of the probes 20.

To stop the microstructures and/or probes 20 at a certain depth in the cavity 4, also the connector part 3 of the microstructure 20 can be made wider at a certain distance above the bottom of the connector part 3. This may be done step-wise or by using a connector part 3 having, for example, a conical shape. The distance above the bottom of the connector part 3 defines the depth at which the connector part 3 can be inserted into the cavities 4. Stopping the probes 20 at a certain depth can also be achieved when probes 20 are mounted in groups (see FIG. 1). In that case, connecting parts 3 of neighbouring probes 20 may be connected to each other by connecting bridges 12. Those connecting parts 12 between different microstructures or probes 20 also allow inserting the probes 20 until a certain depth into the cavities 4.

On the connector part 3 of the microstructure 20 there can be conductive lines 13 or conductive areas electrically connected to the individual sensors at the top of the probes 20 and electrodes 5 on the shaft (see FIG. 1). In-plane to off-plane electrical connection can be made between the microstructures 20 and the base 1. Microstructures 20 which are assembled orthogonally or under an angle to the base 1 can be electrically connected to the base 1. The microstructures 1 can be designed such that only in-plane electrically conductive, e.g. metal, lines and/or areas on both the probe 20 and the base 1 are used. This is advantageous because in-plane electrically conductive, e.g. metal, lines and areas can easily be prepared with standard deposition and patterning techniques, in contrast to 3-dimensional contacting structures. Thereby the device allows making electrical contact between the in-plane electrically conductive, e.g. metal, lines/areas on the probe 20 and in-plane electrically conductive, e.g. metal, lines/areas/flaps on the base 1.

Electrical connectivity between the electrodes 5 on the microstructure shaft 2 and electrodes on the base 1 can be provided by building overhanging electrically conductive blades or flaps 7 on the edge of the cavities 4 in the base 1 in which the microstructures 20 are introduced. These blades 7 are matching with electrically conductive areas on the connector part of the microstructures 20.

The overhanging contact blades 7 fold into the assembly cavity upon insertion of the connector part 3 of the microstructures (FIG. 2). Once inserted, the blade 7 is squeezed between the sidewall of the cavity 4 and the microstructure 20. The electrodes and/or conductive areas and/or conductive lines on the connector part 3 of the microstructure 20 can match the overhanging blades on the base 7. The locations of the conductive areas on the connector part 3 can be chosen such that there is electrical contact between these conductive areas and the blades 7 on the base 1, when bent into the cavity 4 after insertion of the microstructure 20. Insertion allows electrical connectivity between two perpendicular contact pads. In case of a small difference in dimensions between the probes 20 and the cavities 4, electrical connection can be achieved between electrically conductive, e.g. metal, blades 7 on the base 1 and the electrically conductive, e.g. metal, lines on the probes 20. In that case electrical connection can, for example, be realised by metal caulking.

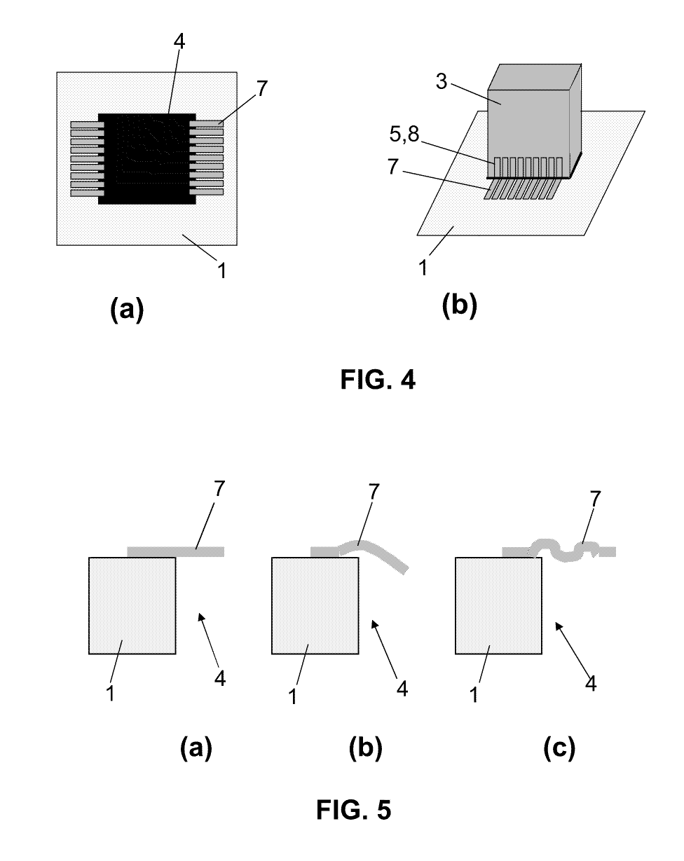

The present structure allows making a plurality of connections per microstructure 20, as illustrated in FIG. 4. It enables multiple, high density interconnects between parts. FIG. 4(a) shows a top view of the cavity 4, which depicts a plurality of overhanging connecting blades 7 which enable multiple electrical connections per microstructure 20. The lines depict metal tracks that end as overhanging blades 7 on the cavity 4. Connecting blades 7 can be extensions of conventional in-line electrically conductive, e.g. metal, tracks on the base 1 and are therefore compatible with various interconnecting schemes such as e.g. wire bonding.

FIG. 4(b) depicts the connector part 3 of a microstructure 20 inserted in a cavity 4. The picture shows in-line electrically conductive, e.g. metal, tracks or electrodes 5 and/or connector pads 8 on the microstructure 20 which match the connecting blades 7 (horizontal lines) on the base 1.

When the dimensions, i.e. shape and sizes, of the connector part 3, the cavity 4 and the overhanging blades 7 are well-chosen, locking of the microstructure 20 in the base 1 can be obtained by the overhanging blades 7, by thermal shrinkage of the connector part 3, and/or by thermal expansion of the cavity 4. The electrical connection can be made by pressing the electrical connections of the probes 20 against the conductive blades 7 on the base 1, by caulking or by any other method used in the field.

The width of the overhanging blades 7 can be between 1 μm and 100 μm, between 2 μm and 100 μm, between 5 μm and 50 μm, or between 10 μm and 30 μm and the length of the overhanging blades 7 can be between 1 μm and 100 μm, between 2 μm and 100 μm, between 3 μm and 50 μm, or between 5 μm and 20 μm. The thickness of the overhanging blades 7 can be in between 0.5 μm and 10 μm, for example between 1 μm and 5 μm or between 1.5 μm and 2 μm.

The pitch between blades 7 depends on the number of electrodes 5 on the microstructure 20. For instance, a five-electrode probe arrangement can use a 70 μm pitch between overhanging blades 7. The interconnect density can be increased by using smaller pitches, for example between 100 μm and 20 μm, between 80 μm and 30 μm or between 70 μm and 35 μm.

Changing the elastic and/or mechanical properties of the blades 7 can allow improved clamping the microstructure or probe 20 in the base 1 and may improve the electrical contact between the electrodes 5 on the microstructure or probe 20 and the base 1. Also using another material, for example elastic material, underneath the blades 7 can facilitate clamping of the microstructure or probe 20 in the base 1.

The blades 7 can have different shapes or geometries. This results in different mechanical and elastic properties. FIG. 5 shows different implementations for the conductive blade 7. The blades 7 may have different shapes. For example, they can be straight lines (FIG. 5(a)), for example to relieve the stress imposed on the blade during insertion. The blades 7 can also bend slightly inside the cavity 5 (FIG. 5(b)) for example to provide additional spring action to ensure that the blade 7 is actually pushing against the matching conductive strip on the microstructure 20. Or the blades 7 can have a wave-like shape (FIG. 5(c)) for example to facilitate mechanical clamping of the microstructure 20 into the cavity 4. To increase the stiffness of the blade 7 during bending, the blade geometry and/or blade cross section can be changed. For example, T-, I- or U-profiles (in cross-section) may have different stiffness properties.

For changing the elasticity or mechanical properties of the overhanging blade 7, different conductive materials and/or different metals, compounds of different metals and/or conductive materials, stacks of different metals and/or conductive materials, or stacks of metals and other conductive and non-conductive materials (with a conductive material at the top) can be used. Examples are Au/Sn alloys and Au/In alloys. To provide higher elastic properties the conductive material can be deposited on polymeric materials, for example silicone, BCB (Benzocyclobutene) and/or polyimide.

The blades 7 on the base 1 and the conductive areas on the probes 20 can be made of any conductive material. This can be a semiconductor, a conductor, a metal, such as Cu, Au, Ag, Al, or any other material that is used in the field.

These conductive regions can also be made by CMOS processing techniques, including deposition and patterning. Therefore it can be interesting to chose conductive materials that can be processed with CMOS techniques, such as Cu and Al, among others.

To facilitate bending of the blades 7 in the cavities 4, the blades 7 can be made of a flexible conductive material, such as gold (Au), copper (Cu), or Indium (In).

The conductive material of the blades 7 and the conductive areas of the probe 20 can be the same material or can be a different material. In the preferred case, the conductive materials of the blades 7 and of the probes 20 are chosen such that they realise good electrical connection.

Particular materials allow improving the electrical contact between conductors on the connector part 3 of the microstructure or probe 20 and the blades 7 upon heating the microstructure 20. An example is an Au/In alloy, whereby Indium changes shape and makes good electrical contact upon heating.

The blades 7 and/or conductive areas can be made of a single material or of different materials. In case of different materials a layered structure can be used. In case only one material is used, only conductive materials can be used. In case different materials are used to form the blades 7, a combination of conductive and non-conductive materials (for example flexible materials for clamping purposes) can be used.

The electrical contact between a blade 7 on the base 1 and the contacting pad 8 on the out-of-plane structure or probe 20 can be improved by depositing a solder material on the blade 7. After assembling the out-of-plane structure 20 into the base 1, a low temperature annealing can be applied. In this way the solder will reflow and an intermetallic compound is formed between the blade 7 and the contact pad 8. Different solder materials can be used such as In and Sn.

The microstructure 20 and the base 1 can, in addition to the blades 7, also be secured together for example by gluing, bonding, welding or by means of a built-in clamping or locking mechanism. An example of such a built-in clamping mechanism is represented in FIGS. 3 (b) and (c). In that case, as already discussed above, the built-in clamping mechanism may comprise two flexible beams, e.g. silicon beams 15a, which are movably attached to a sidewall of the cavity 4. The flexible beams, e.g. silicon beams 15a, can be fabricated such that they bend into the cavity 4 in between the connector part 3 and the sidewalls of the cavity 4 upon insertion of the probe 20. When the dimensions and the material properties of the beams 15a are well-chosen, the connector part 3 may be fixed inside the cavity 4. Also other clamping mechanisms can be used. Electrical and microfluidic connectivity between the matching features can be provided, while maintaining mechanical integrity.

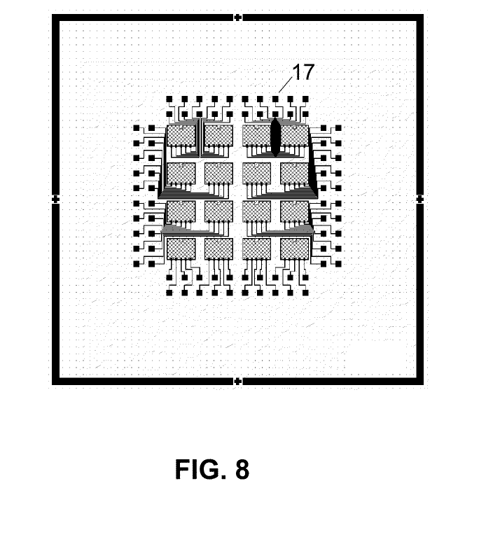

The conductive blades 7 on the base 1 can be connected to other circuitry via conductive lines 16 on the base or the substrate 1 (see FIG. 7). The conductive blades 7 on the base 1 can for example be connected to bond pads, conductive strips or integrated circuitry or CMOS circuitry on or in the base or substrate 1. The overhanging conductive blades 7 on the base 1 can also be electrically connected to external circuitry. To facilitate the connection to external circuitry, larger electrically conductive, e.g. metal, blades 1 or bond pads 17 can be added on the base, that are electrically connected with the electrically conductive, e.g. metal, blades 7 and lines on the base 1, for example by using conductive lines. An example of such wiring is illustrated in FIG. 8. The connection between the base 1 and external circuitry can be done for example using highly flexible ribbon cables for example polyimide or silicone. Any other method to connect the electrically conductive, e.g. metal, lines or blades 7 on the base 1 to other equipment can be used.

To avoid short circuits between the different electrodes, the probe 20 and/or base 1 can be made out of insulating material. Examples are silicon with low conductivity, ceramics, glass, SU8-photoresist, PDMS (polydimethylsiloxane) or other polymers. The probe 20 and/or base 1 can also be made of any other material provided that it is covered with an insulating material and thus which comprises at least a surface of an insulating material, on which the electrodes are created. For example, the probe 20 and/or base 1 can be made of semiconductor material, e.g. silicon, covered with a silicon dioxide layer. The microstructure 20 can also be coated with a biocompatible coating such as parylene, polyimide or BCB or any other biocompatible material.

The electrodes and/or conductive areas and/or interconnecting tracks and/or conductive lines on the probe 20 and base 1 can be made of any conductive material. For the conductive material a metal can be used such as platinum, gold, aluminum, copper, titanium, gold, or copper. For biocompatibility, titanium, platinum and gold can be used. Also other biocompatible materials can be used.

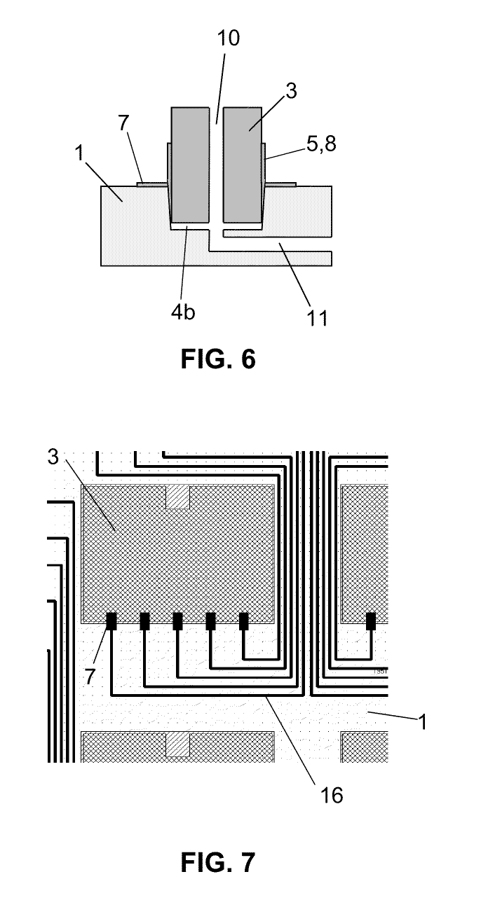

For some applications microfluidic channels can be included in probes 20 and in the base 1 (see FIG. 6). Microfluidic channels 10 in the probe 20 arrive in the connector part 3 of the probe 20. These can then be connected to microfluidic channels 11 in the base 1, terminating at one side in the cavities 4 in the base 1. The channels 11 in the cavities 4 can be located such that they are contacting the channel(s) 10 in the connector part 3 of the probe 20. This is schematically shown in FIG. 6, which depicts a cross-section view of a connector part 3 of a probe 20 assembled in a base 1, including microfluidic channels 10, 11 respectively in the probe 20 and in the base 1. To process microfluidic channels 10, 11, for example in semiconductor material such as e.g. silicon, different fabrication technologies can be used, for example bulk micromachining or surface micromachining. When the microfluidic channels 11, 12 are processed in plastics, injection moulding, hot embossing, casting techniques and lamination techniques can be used.

From FIG. 6, it can be observed that, once assembled, there can still be a part 4b of the cavity 4 left between the base 1 and the probe 20. So the microfluidic channels 10, 11 of both the probe 20 and the base 1 can lead to the cavity 4b between them—which can be sealed by the securing process—thereby forming a single microfluidic conduit running between the two connecting microstructures. Sealing between the two parts should allow electrical connections and connecting microfluidics. Methods for the sealing of the junction between the probe 20 and the backbone 1 include (but are not limited to) using a glass frit or a previously deposited layer (on the probe 20 as well as on the backbone 1) of low melting point glass (such as different types of spin-on glass); once the probes 20 are inserted, the whole structure is heated up and the glass layers are bonded to each other.

At the other side of the base 1, the microfluidic channels 11 in the base 1 can terminate at measurement and/or fluid-control equipment. This can allow the transport of fluids from the probes 20, through the base 1, towards other equipment, as well as in the opposite direction.

These microfluidic channels 10, 11 can be used for drug delivery, i.e. the administration of drugs, for example in case of cerebral applications.

Also other types of probes 20 can be designed to match the common backbone 1. As the different probes 20 and the backbone 1 can be designed independently, diverse probe configurations can be generated, thereby extending the versatility of the resulting probe arrays.

The probes 20 can also comprise functional regions connected via conductive areas or wires with the conductive blades 7. That way conductive strips, wires or areas on the connector part 3 of the microstructure or probe 20 can be electrically connected to functional regions on the microstructure or probe 20. These functional regions on the microstructure or probe 20 allow different measurements and can also allow activation. When the microstructure or probe 20 is inserted in a cavity 4, the overhanging conductive blades or flaps 7 bend inside the cavity 4 and are contacting the conductive strips on the connector part 3 of the microstructure or probe 20.

The base 1 with cavities or holes 4 should at least have an insulating surface on which the electrically conductive, e.g. metal, blades 7 and electrodes can be created. According to embodiments, the base 1 may be formed of an insulating material such as e.g. a polymer. According to other embodiments, the base 1 may be formed of a semiconductor material such as silicon having an insulating layer on top. Thereby, for example biocompatible materials can be used to form an insulating layer. The base 1 can be made using moulds in which a polymer is introduced. Thereby LIGA (X-ray lithography) can be used. SU8-photoresists or PDMS can be used as a material to be introduced in the mould. The base 1 can also be made in a silicon wafer using CMOS processing techniques. Also other methods for making the base 1 can be used.

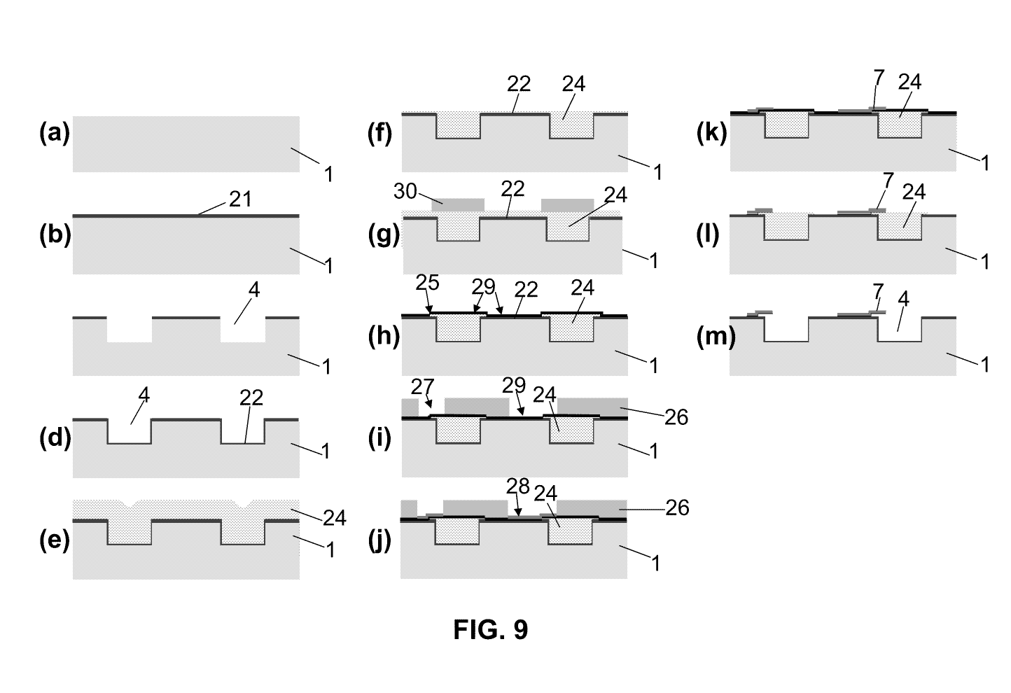

Below, a fabrication method for the base 1 is described, in the example given starting from a semiconductor substrate such as e.g. a Si substrate. It should be understood that this is only by way of an example and that this is not intended to limit the invention in any way. FIG. 9 in its sub-sections shows subsequent steps of the exemplary fabrication process. First, a base 1 with cavities or holes 4 can be created. Afterwards, the overhanging electrically conductive, e.g. metal, blades 7 can be fabricated. The overhanging blades 7 can be fabricated using a process based on planarization.

A semiconductor substrate 1, for example a silicon wafer (FIG. 9(a)) can be coated with a layer 21 (FIG. 9(b)) that can be used as an etch mask for etching the cavities or holes 4. On silicon, for example PECVD (Plasma Enhanced Chemical Vapour Deposition) silicon dioxide can be used. This layer can be patterned, for example by RIE (reactive ion etch) to serve as an etch mask for etching the cavities or holes 4 in the silicon wafer. This last can be done by DRIE (deep reactive ion etch) (FIG. 9(c)). The wafer 1 provided with cavities 4 can then be coated with an insulating material 22, for example a PECVD oxide layer (FIG. 9(d)).

To start the fabrication of the overhanging blades 7, the substrate or wafer 1 can be planarized with a sacrificial material 24 at the side of the cavities 4. The sacrificial material 24, which may also be referred to as planarizing material, can be chosen such that there is already a high degree of planarization after depositing the sacrificial material 24. To limit problems during further processing, outgassing of the sacrificial material 24 as such can be limited. To fill an etched cavity 4, that can be several hundred microns deep, a thick viscous material can be used. If the sacrificial material 24 does not fill the cavities 4 completely, there can be holes in the sacrificial material 24 containing gasses that might be outgassing during further processing: this may cause problems during further processing. So in the best case, the material 24 can fill the cavities 4 completely. If needed, the planarizing material 24 can be cured. Examples of planarizing sacrificial materials 24 are polyimide (PI2525, DuPont), BCB (XU35075 Dow Company) as well as certain spin-on-glasses. The sacrificial material 24 can be deposited over the entire surface (FIG. 9(e)). The sacrificial material 24 may be provided for example by spin coating. In order to easily remove the sacrificial material 24 later in the process flow, in embodiments where an imidized polymer is used as the sacrificial material 24, it may be advantageous if the polymer is not completely imidized.

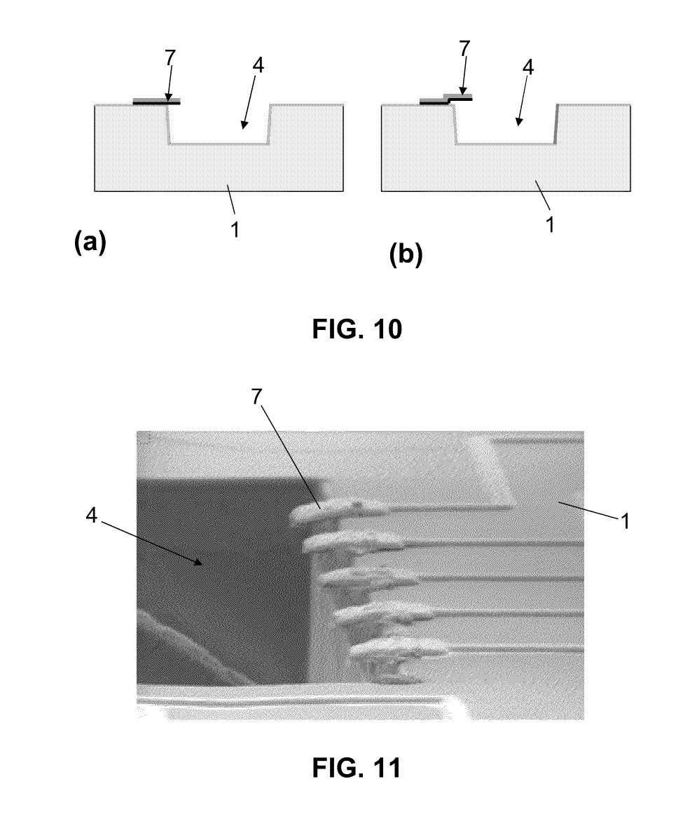

For some applications bending of the blade 7 may be needed as illustrated in FIG. 10(b). Therefore the excess sacrificial material 24 above the wafer surface may be reduced to a thickness of ˜5 μm using a planarizing process (FIG. 9(f)), for example thinning the surface with a wafer grinder (DFG8560, Disco Corp.) or Fly cutter (DFS8910, Disco Corp.). A lithography step can be performed to define a region slightly bigger than the original cavity 4 (in the process step represented in FIG. 9(g)), e.g. by providing a mask 30 and then removing the material not covered by the mask 30. The purpose of this is to create a small step 25. The step 25 will be transferred to any blade 7 made on this step. This step 25 in the blade 7 will facilitate the folding of the blade 7 into the cavity 4 and will avoid the blade 7 from breaking while it is pressed against the sharp edge of the cavity 4. Subsequently, the planarizing material (for example polyimide or BCB) in between the cavities 4 is removed (FIG. 9(g)). This can be done by, for example, plasma etching, wet etching or reactive ion etching. But any other suitable method to etch/remove this material known by a person skilled in the art can be used. As a consequence, the planarizing material 24 (for example polyimide) remains in the areas slightly larger than the cavities, i.e. protected in the previous step,

If the sharp edge of the cavity 4 doesn't cause problems during bending of the blade 7, the blade 7 can be straight (see FIG. 10(a)). In that case, the excess of planarizing material 24 is completely removed in FIGS. 9(e) and (f), such that there is no step 25 above the etched cavities or holes, in contrast to FIG. 9(g).

Subsequently, the overhanging blades 7 and connecting lines and conductive areas can be fabricated. This can be done by deposition and patterning of electrically conductive material, e.g. metal. In one approach, electrically conductive material, e.g. metal, is deposited all over the surface, followed by lithography and dry and/or wet etching. In another approach, patterns are defined in for example a resist layer 26 defining the locations of the electrically conductive, e.g. metal, tracks and overhanging blades or flaps 7. This is followed by the deposition of an electrically conductive, e.g. metal, layer on the entire surface. Then the excess electrically conductive layer, e.g. metal, on top of the resist is removed by a lift-off technique. Electrically conductive, e.g. metal, tracks remain on the regions not protected by the resist.

Overhanging blades 7 and connecting lines and conductive areas can also be fabricated by plating. An example is given in case of gold, but any other material that can be plated can be used. A seed layer 29, for example TiW/Au/TiW or Ti/Au/Ti can be deposited, by for example sputtering (FIG. 9(h)). This is followed by another lithography step, which defines the regions where metallic (for example gold) interconnects and the overhanging blades 7 will be created. A resist layer 26 is patterned, thereby creating holes 27 in the resist layer 26 at the locations where the electrically conductive blades 7, connecting lines and conductive areas are to be created (FIG. 9(i)). An electrically conductive, e.g. metallic, layer 28, for example gold, can then be deposited, using for example electroplating (FIG. 9(j)). This will be plated on the regions not protected by the patterned resist layer 26. Afterwards, the resist layer 26 can be removed (FIG. 9(k)) as well as the remaining seed layer (FIG. 9(l)), thereby leaving the overhanging blades 7 and interconnects. Finally, the sacrificial planarizing layer 24 (for example polyimide) can be completely removed from the cavities 4, with, in case of polyimide, for example a NaOH or KOH base solution, Microstrip 2001 (Olin Microelectronic Materials), or EKC265 which results in the structures shown in FIG. 9(m). In case BCB is used as sacrificial layer, Primary stripper A (Dow Company) can be used. That way overhanging blades 7 on cavities 4 can be created.

Such fabrication methods can, for example, be used to make a device for recording single neuron electrical activity in the brain. The device comprises an array of probes 20, for example needles. These probes 20 may have different functionalities. The probes 20 can comprise a plurality of electrodes 5 or other biological applications or microfluidic channels 10, 11. These probes 20 can be inserted in cavities 4 in a base 1, the cavities 4 comprising overhanging blades 7 that are bent into the cavities 4 to ensure electrical contact to the electrodes 5 on the probes 20. The base 1 can be made thin, which is advantageous when placed in the skull. The modular approach allows choosing probe shape, size and functionality suited for applications involving complex brain regions; it enables the integration of electrical, microfluidic and biosensor probes within the same base 1. Biosensors can be integrated on the probe shafts 2. They can be used for in-vivo monitoring of chemical substances in the brain. That way exploration of fundamental processes and the interaction of chemical and electrical information transfer in the brain can be assessed. Other biological applications such as neuronal stimulation in the brain, peripheral nerve recording and stimulation, biochemical probing of organs such as the liver, are also envisaged.

Once the base is obtained, for example through the above process, probes 20 or comb-like groups of probes 20 can be inserted into the cavities 4. In this embodiment, the probes 20 can be secured to the cavity 4 by using adhesive such as medical-grade cyanoacrylate adhesive or locally-applied spin-on glass.

### Experimental Results

A probe 20 was made of silicon and comprises a chisel-type tip, a needle-like silicon shaft 2, and a connector part 3 at the bottom (see FIG. 1). Each probe 20 had a sharp tip with an angle of 17°. The length of the combined tip and silicon shaft varied from 2 to 9 mm. The shaft 2 had a width of 120 μm and a thickness of 100 μm. The dimensions of the base of the probe were 297 μm by 395 μm (corresponding to the dimensions of the cavity being 300 μm by 400 μm). Combs with 4 probes 20 were made (see FIG. 1), that could be inserted into a base 1. On each probe shaft 2 there were a number of equidistantly distributed electrodes 5. The number of electrodes 5 varied between five and nine electrodes 5 per probe 20. The electrodes 5 were connected to metal contacts at the bottom of the probe 20, which were matching the overhanging connecting blades 7 on the base 1.

In the silicon backbone 1 there was an array of 4×4 cavities 4 covered by silicon oxide. The size of each cavity 4 was 300 μm×400 μm, with a small notch of 50 μm×50 μm to facilitate alignment. The pitch between cavities was 550 μm×550 μm. The backbone 1 was made out of silicon covered with a SiO₂ layer.

For electrical connectivity, overhanging conductive Au blades 7 on the edge of the cavities 4 were made. They were located such that they were matching the conductive blades 7 with conductive strips on the connector part 3 of the probe 20 (see FIGS. 2(a), 11, and 12). The overhanging blades 7 were made of gold and had a thickness between 2 μm and 4 μm. The overhanging blades 7 are 20 μm wide and their overhanging parts were in between 5 μm to 20 μm long. The pitch between blades 7 depended on the number of electrodes 5 envisaged for the probe 20. In case of a five-electrode probe arrangement, a 70 μm pitch between overhanging blades 7 was used.

Upon insertion (FIGS. 2(b), (c), (d)), such blades 7 were pushed into the cavity 4 in the base 1 and were then squeezed between the side wall of the cavity 4 and the conductive strips of the connector part 3, thereby establishing electrical contact. This is illustrated in FIG. 2 (d) (lateral cross-section). The probes 20 were mechanically secured to the cavity 4. FIG. 13 shows a comb-like group of probes 20 assembled on the backbone 1.

The electrical interconnection of the electrodes 5 to an external circuitry was obtained via conductive wires or interconnecting tracks on the common backbone 1. Therefore the overhanging contact blades 7 were connected to conductive wires or interconnecting tracks on the backbone 1 (FIGS. 7, 8, 11, and 12). These interconnecting tracks on the base were made of gold.

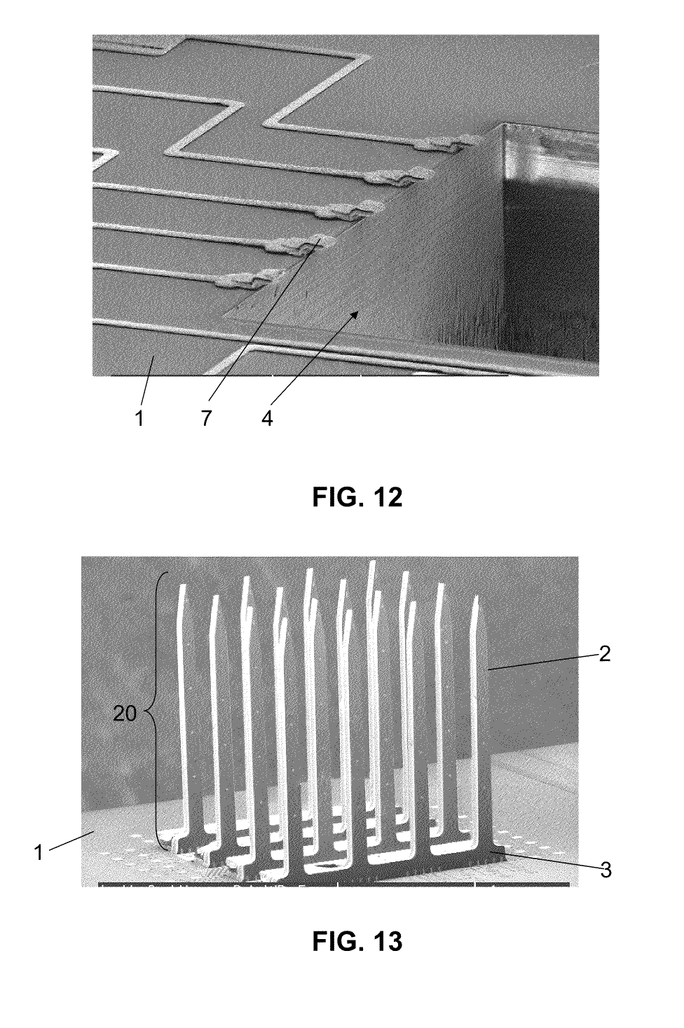

The fabrication process of the base or support 1 is represented in FIG. 9. A silicon wafer 1 (FIG. 9(a)) was coated with PECVD silicon dioxide (FIG. 9(b)), which was patterned to serve as the etch mask for the next step, which consists of a DRIE (deep reactive ion etch) of silicon to obtain the cavities (FIG. 9(c)) where probes 20 will be inserted. After this, a second PECVD oxide layer was deposited (FIG. 9(d)). At this stage the wafer was planarized in order to start the fabrication of the overhanging blades 7. A thick layer 24 of BCB (XU35075, Dow company) is applied over the entire surface and soft baked (FIG. 9(e)). The excess BCB material above the wafer surface was reduced to a thickness of 5 μm using a wafer grinder (DFG8560, Disco Corp.) (see FIG. 9(f)). A lithography step was performed to define a region slightly bigger than the original cavity 4. The remaining BCB (except for the areas protected in the previous step, which include the cavities) was then removed using reactive ion etching (FIG. 9(g)). A seed layer comprising of TiW/Au/TiW was then deposited by sputtering (FIG. 9(h)). This was followed by another lithography step (FIG. 9(i)), which defines the regions where gold interconnects (including the overhanging blades 7) will be created. FIGS. 11 and 12 show details of a group of blades 7 at this step. Gold was then deposited through electroplating (FIG. 9(j)) and the resist (FIG. 9(k)) and remaining seed layer were removed (FIG. 9(l)). Finally the BCB was completely removed from the cavities 4 using Primary stripper A (Dow company) (FIG. 9(m)). The resulting cavity 4 with overhanging Au blades 7 is shown in FIGS. 11 and 12, i.e. a scanning electron micrograph of the cavity 4 at an angle, showing the overhanging connecting blades 7 on the cavity 4.

Assembly of the microstructures or probes 20 was done with a flip chip bonder (Suss FC150 automatic flip chip bonder). To enhance the assembly and to ensure mechanical clamping, the bottom chuck was heated till 250° C. while the tooling chuck, containing the microstructure or probes 20 was kept at room temperature. As a result the cavities 4 expanded due to the thermal expansion coefficient. After assembly the platform was cooled down. As a result the microstructure or probes 20 were fixed into the base 1.

It is to be understood that although preferred embodiments, specific constructions and configurations, as well as materials, have been discussed herein, various changes or modifications in form and detail may be made without departing from the scope of this invention as defined by the appended claims.

1. A device comprising:
a substrate with at least one cavity, wherein the substrate and the cavity have at least an insulating surface;
at least one microstructure comprising a connector part and at least one shaft, the connector part being inserted in said cavity, the microstructure comprising at least one conductive area extending at least partially on the connector part and at least partially on the shaft;
at least one flexible conductive blade at the cavity, a first part of the conductive blade being outside the cavity and a second part being inside the cavity between the connector part and a sidewall of the cavity, such that the conductive blade is in electrical contact with the conductive area of the microstructure.

2. A device according to claim 1, wherein the dimensions of the cavity substantially match the dimensions of the connector part of the microstructure.

3. A device according to claim 1, wherein the cavity and the connector part have dimensions between 50 μm and 2000 μm.

4. A device according to claim 1, wherein an angle between the substrate and the microstructure is between 45° and 90°.

5. A device according to claim 1, wherein the width of the conductive blade and the length of the second part of the conductive blade is between 1 μm and 100 μm.

6. A device according to claim 1, further comprising conductive paths on the substrate for connecting the conductive blade with bond pads or integrated circuitry in the substrate.

7. A device according to claim 1, further comprising functional areas on the microstructure in contact with the conductive area.

8. A device according to claim 1, further comprising a first microfluidic channel in the substrate and a second microfluidic channel in the microstructure, the first and second microfluidic channels being connected to each other with at least one sealed hole in the cavity.

9. A device according to claim 1, wherein the microstructure is a needle.

10. A device according to claim 1, wherein the substrate has a thickness between 200 μm and 2000 μm.

11. A device according to claim 1, wherein the substrate is a semiconductor wafer or a thinned semiconductor wafer covered with insulating material.

12. A device according to claim 1 wherein the conductive area and the blade comprise at least one conductive material.

13. A device according to claim 1, wherein the blade comprises a flexible material.

14. A device according to claim 1, wherein the substrate, the microstructure, the conductive blade, and the conductive area are made of or covered with biocompatible materials.

15. Use of a device according to claim 1 for measurements or actuation.

16. Use of a device according to claim 1 for measurements or actuation of neural activity.

17. A method comprising:
obtaining a substrate with at least one cavity, the substrate and the cavity having an insulating surface, the substrate further having at least one flexible conductive blade near each cavity, said conductive blade partially overhanging the cavity;
obtaining at least one microstructure comprising a connector part, at least one shaft, and at least one conductive area extending at least partially on the connector part and at least partially on the shaft, the connector part being shaped such as to fit into the cavity, the conductive area being located so as to contact the conductive blade upon insertion of the connector part into the cavity;
inserting the connector part of the microstructure into the cavity, thereby bending the conductive blade in the cavity and realizing electrical contact between the conductive blade and the conductive area; and
fixing the connector part inside the cavity.

18. A method according to claim 17, further comprising fabricating at least one functional area on the microstructure in contact with the conductive area.

19. A method according to claim 17, further comprising providing at least one bond pad on the substrate or integrated circuitry in the substrate and providing at least one conductive path on the substrate connecting the flexible conductive blade with the bond pad or integrated circuitry.

20. A method according to claim 17, further comprising:
providing a first microfluidic channel in the substrate;
providing a second microfluidic channel in the microstructure, whereby the first microfluidic channel is connected to the second microfluidic channel via a hole in the cavity; and
sealing the hole in the cavity.

21. A method according to claim 20, further comprising connecting the flexible conductive blade or the microfluidic channels to measurement equipment.

22. A method according to claim 17 wherein providing the flexible conductive blade comprises:
filling the cavity with a sacrificial material;
providing at least one conductive blade partially on the sacrificial material; and
removing the sacrificial material from the cavity.

23. A method according to claim 22 wherein the sacrificial material is polyimide or Benzocyclobutene (BCB).

24. A method according to claim 17, wherein providing the flexible conductive blade and the conductive path is done by metal deposition and lift-off, or by metal deposition and patterning by dry or wet etching.

25. A method according to claim 17, wherein realizing electrical contact between the conductive blade and the conductive area is done by caulking.

26. A method according to claim 17, wherein the dimensions of the connector part are slightly different from the dimensions of the cavity, and fixing the connector part in the cavity comprises:
creating a temperature difference between the substrate and the connector part such as to allow insertion of the connector part into the cavity;
inserting the connector part into the cavity; and
bringing the substrate and the connector part to the same temperature.

27. A device comprising:
a substrate having a plurality of cavities;
a plurality of flexible conductive blades on the substrate, each of these conductive blades extending into a cavity; and
a plurality of microstructures, each microstructure comprising a connector part and a shaft;
wherein the connector part of each microstructure extends into one of the cavities and is resiliently engaged by at least one of the conductive blades, and the shaft of each microstructure extends above the surface of the substrate; and
wherein at least one of the microstructures is a probe that includes at least one electrode on the shaft and at least one connector pad on the connector part, the connector pad being electrically connected to the electrode and to at least one of the conductive blades.

28. A device according to claim 27, wherein a plurality of the shafts extend substantially orthogonally from the substrate.

29. A device according to claim 28, wherein the cavities are arranged in a substantially two-dimensional array.

30. A device according to claim 27, wherein at least one of the microstructures is a probe that includes a plurality of electrodes at different positions along the shaft, each electrode being electrically connected to a respective one of the connector pads, and each of the respective connector pads being connected to a respective one of the conductive blades.

31. A device according to claim 30, wherein the plurality of electrodes on the plurality of probes collectively form a three-dimensional array.

32. A device according to claim 27, further comprising:
at least one first microfluidic channel extending through the substrate and terminating at a cavity; and
a second microfluidic channel extending through at least one of the microstructures;
wherein the first and second microfluidic channels are in fluid communication with one another.

33. A device according to claim 32, further comprising fluid-control equipment in fluid communication with the microfluidic channels, the fluid-control equipment being operative to dispense a drug through the microfluidic channels.

34. A device according to claim 33, further comprising recording equipment in electrical communication with at least one of the probes.

35. A device according to claim 27, wherein at least one of the microstructures includes a temperature sensor.

36. A device according to claim 27, wherein at least one of the microstructures includes a biosensor for detecting biomolecules.

37. A device according to claim 27, further comprising, a plurality of bond pads on the substrate forming electrical connections with respective conductive blades.

38. A device according to claim 27, further comprising integrated circuitry on the substrate, wherein the integrated circuitry forms electrical connections with the conductive blades.

39. A device according to claim 1, further comprising clamping structures in at least part of the cavities of the substrate for clamping the connector parts of the microstructures in the cavities.

40. A device according to claim 39, wherein each of the clamping structures comprises at least one flexible beam attached to a sidewall of the cavity in which it is located, and wherein there is a gap in between the bottom of the cavity and the clamping structure.

41. A method according to claim 17, further comprising fabricating clamping structures in at least part of the cavities of the substrate for clamping the connector parts of the microstructures in the cavities.

42. A method according to claim 41, wherein each of the clamping structures comprises at least one flexible beam attached to a sidewall of the cavity in which it is located, and wherein each of the clamping structures is positioned to leave a gap between the bottom of the cavity and the respective clamping structure.

43. A device according to claim 27, further comprising clamping structures in at least part of the cavities of the substrate for clamping the connector parts of the microstructures in the cavities.

44. A device according to claim 43, wherein each of the clamping structures comprises at least one flexible beam attached to a sidewall of the cavity in which it is located, and wherein there is a gap in between the bottom of the cavity and the clamping structure.
